(19) United States
(12) Patent Application Publication
(10) Pub. No.: US 2022/0025959 A1
(43) Pub. Date: Jan. 27, 2022

(54) REDUCTION GEAR

(71) Applicant: ENPLAS CORPORATION, Saitam (JP)

(72) Inventor: Yasushi KAJIWARA, Saitama (JP)

(21) Appl. No.: 17/299,504

(22) PCT Filed: Jan. 10, 2020
(86) PCT No.: PCT/JP2020/000557

§ 371 Date: Jun. 3, 2021

(51) Int. Cl. F16H 1/32; F16H 25/06

(52) U.S. Cl. CPC F16H 1/32; F16H 2001/323; F16H 2001/325; F16H 25/06

(57) ABSTRACT

A reduction gear has pins that extend across and contact a first swing body and a second swing body and are swung by the first swing body and the second swing body. A first radial direction groove forming body has radial direction grooves formed in the same number (Za) as the pins to allow the pins to slide in a radial direction. A second radial direction groove forming body has radial direction grooves formed in the same number as the pins to allow the other ends of the pins to slide in the radial direction. A wave shape depressed portion forming body has wave shape depressed portions contacting the pins formed along a circumferential direction (Zb). Then, the difference between Za and Zb is 1.

### TECHNICAL FIELD

The present invention relates to a reduction gear used to decelerate and transmit rotation.

### BACKGROUND ART

Since a gear reducer that has been generally used conventionally is configured by combining a plurality of gears, it is difficult to eliminate backlash, and it is also difficult to obtain a compact size and a large reduction gear ratio. Therefore, a reduction gear (cycloid reduction gear) as shown in FIG. 19 has been developed to solve the drawbacks of the gear reducer.

FIG. 19 is a diagram illustrating such a conventional reduction gear 100. As illustrated in FIG. 19, in the reduction gear 100, a second ring 103 is relatively turnably housed in a space 102 on a radial direction inner side of a first ring 101. The second ring 103 is relatively turnably engaged with an input shaft (not illustrated) via a bearing, and accordingly, the second ring 103 is mounted to the input shaft in an eccentric state. Further, in the reduction gear 1, a plurality of rollers 106 having an abacus bead shape (shape in which bottom surfaces of a pair of conical bodies are bonded to each other) are turnably supported at regular intervals in a roller cage 107 positioned between the first ring 101 and the second ring 103. The roller 106 can fit in a variable cutout 104 in the first ring 101 and a variable cutout 105 in the second ring 103. Further, in the reduction gear 100, the first ring 101 is secured and an output shaft (not illustrated) is coupled to the second ring 103 to decelerate and transmit the rotation of the input shaft to the output shaft.

The reduction gear 100 illustrated in FIG. 19 operates as the cycloid reduction gear by providing a total number of the variable cutouts 105 in the second ring 103 less than a total number of the variable cutouts 104 in the first ring 101, and a total number of the rollers 106 more than the total number of the variable cutouts 105 in the second ring 103 and less than the total number of the variable cutouts 104 in the first ring 101. For example, the reduction gear 100 illustrated in FIG. 19 can be configured by setting the total number of the variable cutouts 104 in the first ring 101 to 6, setting the total number of the variable cutouts 105 in the second ring 103 to 4, and setting the total number of the rollers 106 to 5. Then, a reduction ratio R of the reduction gear 100 in this case is determined based on the total number N of the rollers 106 and is calculated by a formula of R=(N−1)/2. Accordingly, when the total number of the rollers 106 is 5, the reduction ratio R of the reduction gear 100 becomes 2.

Then, in the reduction gear 100 illustrated in FIG. 19, the second ring 103 which turns in an eccentric state around a shaft center of the input shaft is connected to the output shaft (not illustrated) via an eccentric motion absorbing mechanism, such as an Oldham's joint 108 (see FIG. 20), and rotation of the second ring 103 is smoothly taken out from the output shaft coaxially positioned with the input shaft (see Patent Document 1).
Patent Document 1: JP-T-2018-519482

### DISCLOSURE OF THE INVENTION

### Problems to be Solved by the Invention

However, as illustrated in FIG. 19, when taking out the rotation from the second ring (output member) 103 which turns in the eccentric state (transmitting to the output shaft), the conventional reduction gear 100 requires the eccentric motion absorbing mechanism as illustrated in FIG. 20 (for example, the Oldham's joint 108), and consequently, there has been a problem that the structure becomes complicated as well as enlarged enough to accommodate the eccentric motion absorbing mechanism.

Therefore, the present invention has an object to provide a reduction gear which allows rotation of an output member to be taken out without going through an eccentric motion absorbing mechanism and allows a structure to be simplified as well as downsized as compared with a case where a separate eccentric motion absorbing mechanism is necessary.

### Solutions to the Problems

The present invention relates to a reduction gear 1 that decelerates and transmits rotation of an input side rotation body 5 to an output side rotation body (2A, 2B).

The reduction gear 1 according to the present invention includes: an eccentric cam 6 that turns together with the input side rotation body 5;

a first swing body 10A relatively turnably fitted to the eccentric cam 6 and swung by the eccentric cam 6 that turns in an eccentric state with respect to a rotation shaft center CL of the input side rotation body 5;

a second swing body 10B that is relatively turnably fitted to the eccentric cam 6, swung by the eccentric cam 6 that turns in an eccentric state with respect to the rotation shaft center CL of the input side rotation body 5, and swung in a state of being shifted by 180° in phase with respect to the first swing body 10A;

a plurality of round rod shaped pins 3 that extend across and contact outer peripheries of the first swing body 10A and the second swing body 10B and are swung by swing motions of the first swing body 10A and the second swing body 10B;

a first radial direction groove forming body 2A, a direction extending radially from the rotation shaft center CL of the input side rotation body 5 being defined as a radial direction, a direction along a circumference of a virtual circle centering on the rotation shaft center CL of the input side rotation body 5 being defined as a circumferential direction, at least a same number of radial direction grooves 4 as a number of the pins 3 being formed in the first radial direction groove forming body 2A, the radial direction grooves 4 allowing one end sides of the pins 3 swung and moved by the first swing body 10A and the second swing body 10B to slidingly move along the radial direction;

a second radial direction groove forming body 2B integrated with the first radial direction groove forming body 2A, at least a same number of radial direction grooves 4 as the number of the pins 3 being formed in the second radial direction groove forming body 2B, the radial direction grooves 4 allowing other end sides of the pins 3 swung and moved by the first swing body 10A and the second swing body 10B to slidingly move along the radial direction; and

a wave shape depressed portion forming body 13 positioned on radially outward sides of the first swing body 10A and the second swing body 10B and having a wave shape depressed portion 28 formed along the circumferential direction, the wave shape depressed portion 28 being into contact with the pin 3 slidingly moved along the radial direction groove 4.

Then, one of the first radial direction groove forming body 2A and second radial direction groove forming body 2B or the wave shape depressed portion forming body 13 is secured to a member to be fixed. Further, another of the first radial direction groove forming body 2A and second radial direction groove forming body 2B or the wave shape depressed portion forming body 13 is arranged relatively turnably with the one of the first radial direction groove forming body 2A and second radial direction groove forming body 2B or the wave shape depressed portion forming body 13, the first swing body 10A, and the second swing body 10B. Further, when the number of grooves of the radial direction grooves 4 is defined as Za and the number of the wave shape depressed portions 28 is defined as Zb, a plurality of the wave shape depressed portions 28 are formed along the circumferential direction of the wave shape depressed portion forming body 13 such that a difference between Za and Zb becomes 1.

### Effects of Invention

In the reduction gear according to the present invention, while the swing body is swung with respect to the rotation shaft center of the input side rotation body, the first radial direction groove forming body and second radial direction groove forming body and the wave shape depressed portion forming body are not eccentrically turned by the swinging swing body, and thus, rotation can be taken out from one of the first radial direction groove forming body and second radial direction groove forming body or the wave shape depressed portion forming body without separately providing the eccentric motion absorbing mechanism which is provided in a conventional cycloid reduction gear, allowing the structure to be simplified as well as downsized.

### BRIEF DESCRIPTION OF THE DRAWINGS

FIG. 1 is an external perspective view illustrating a reduction gear according to an embodiment of the present invention when exploded and viewed from obliquely above.

FIG. 2 is a diagram illustrating the reduction gear according to the embodiment of the present invention. FIG. 2(a) is a front view of the reduction gear, FIG. 2(b) is a side view of the reduction gear, and FIG. 2(c) is a back view of the reduction gear.

FIG. 3 is a cross-sectional view taken along the line A1-A1 of FIG. 2(a) to illustrate the reduction gear.

FIG. 4(a) is a front view illustrating the reduction gear in which a first radial direction groove forming body on a front side is removed, and FIG. 4(b) is a side view illustrating the reduction gear in which the first radial direction groove forming body on the front side is removed.

FIG. 5(a) is a cross-sectional view taken along the line A2-A2 of FIG. 2(a) to illustrate the reduction gear, FIG. 5(b) is a simplified view illustrating the relation between swing set points on one end side of respective pins and respective radial direction grooves of the first radial direction groove forming body, and FIG. 5(c) is a simplified view illustrating the relation between swing set points on the other end side of the respective pins and the respective radial direction grooves of a second radial direction groove forming body.

FIG. 6(a) is an enlarged view of part B1 of FIG. 5(a), and FIG. 6(b) is an enlarged view of part B2 of FIG. 5(a).

FIG. 7 is a simplified view illustrating a swing state (oscillation state) of the pin, and a cross-sectional view taken along the line A8-A8 of FIG. 13(d) to illustrate a wave shape depressed portion forming body.

FIG. 8 is a diagram illustrating an eccentric cam of the reduction gear according to the embodiment of the present invention. FIG. 8(a) is a front view of the eccentric cam, FIG. 8(b) is a side view of the eccentric cam, FIG. 8(c) is a back view of the eccentric cam, and FIG. 8(d) is a cross-sectional view taken along the line A3-A3 to illustrate the eccentric cam.

FIG. 9 is a diagram illustrating an input sleeve of the reduction gear according to the embodiment of the present invention. FIG. 9(a) is a front view of the input sleeve, FIG. 9(b) is a side view of the input sleeve, FIG. 9(c) is a back view of the input sleeve, and FIG. 9(d) is a cross-sectional view taken along the line A4-A4 of FIG. 9(a) to illustrate the input sleeve.

FIG. 10 is a diagram illustrating a swing body (first swing body and second swing body) of the reduction gear according to the embodiment of the present invention. FIG. 10(a) is a front view of the swing body, FIG. 10(b) is a side view of the swing body, FIG. 10(c) is a back view of the swing body, and FIG. 10(d) is a cross-sectional view taken along the line A5-A5 of FIG. 10(a) to illustrate the swing body.

FIG. 11 is a diagram illustrating the relation between the first swing body and second swing body and the pin. FIG. 11(a) is a view illustrating the first swing body and second swing body and the pin as viewed from a front side, FIG. 11(b) is a view illustrating the first swing body and second swing body and the pin as viewed from a side surface side, and FIG. 11(c) is a view illustrating the first swing body and second swing body and the pin as viewed from a back side.

FIG. 12 is a diagram illustrating the first radial direction groove forming body and the second radial direction groove forming body of the reduction gear according to the embodiment of the present invention. FIG. 12(a) is a front view of the first radial direction groove forming body and the second radial direction groove forming body, FIG. 12(b) is a side view of the first radial direction groove forming body and the second radial direction groove forming body, FIG. 12(c) is a back view of the first radial direction groove forming body and the second radial direction groove forming body, and FIG. 12(d) is a cross-sectional view taken along the line A6-A6 of FIG. 12(a) to illustrate the first radial direction groove forming body and the second radial direction groove forming body.

FIG. 13 is a diagram illustrating the wave shape depressed portion forming body of the reduction gear according to the embodiment of the present invention. FIG. 13(a) is a front view of the wave shape depressed portion forming body, FIG. 13(b) is a side view of the wave shape depressed portion forming body, FIG. 13(c) is a back view of the wave shape depressed portion forming body, and FIG. 13(d) is a cross-sectional view taken along the line A7-A7 of FIG. 13(a) to illustrate the wave shape depressed portion forming body.

FIG. 14 is a diagram illustrating a modification 1 of the swing body (first swing body and second swing body) of the reduction gear according to the embodiment of the present invention. FIG. 14(a) is a front view of the swing body, FIG. 14(b) is a cross-sectional view taken along the line A9-A9 of FIG. 14(a) to illustrate the swing body, and FIG. 14(c) is a back view of the swing body.

FIG. 15 is a diagram illustrating a swing state of the pin when the swing body according to the modification 1 is used. FIG. 15(a) is a first swing state view of the pin, and FIG. 15(b) is a second swing state view of the pin.

FIG. 16 is a diagram illustrating a modification 2 of the swing body, and the diagram corresponding to FIG. 7.

FIG. 17 is a diagram illustrating a modification of a pin swing supporting portion, and the diagram corresponding to FIG. 7.

FIG. 18 is a diagram illustrating a modification of the wave shape depressed portion forming body.

FIG. 19 is an external perspective view illustrating a simplified conventional reduction gear.

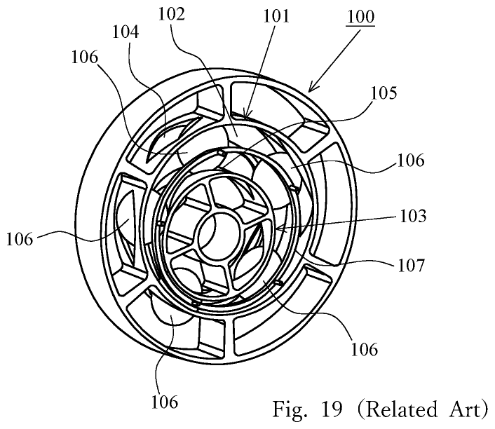

FIG. 20 is an exploded perspective view of an eccentric motion absorbing mechanism (Oldham's joint) of a conventional reduction gear.

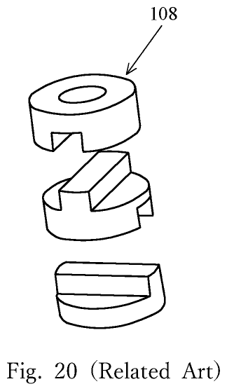

### DESCRIPTION OF PREFERRED EMBODIMENTS

The following describes embodiments of the present invention in detail based on the drawings.

### First Embodiment

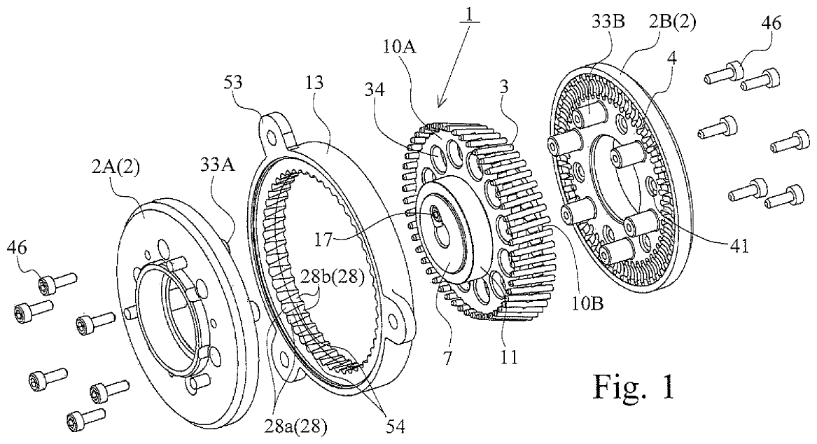

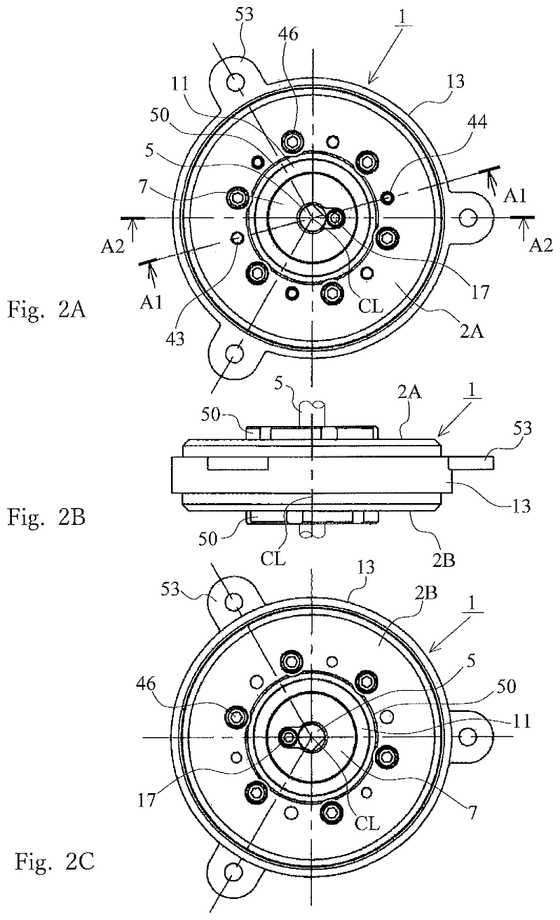

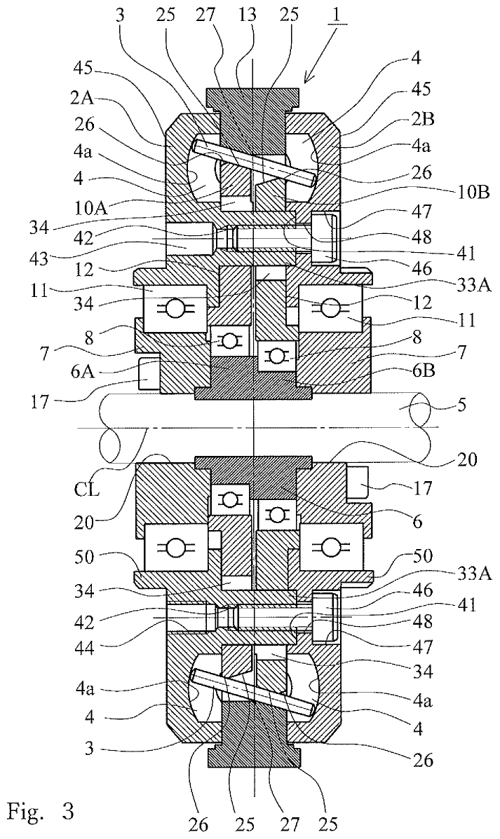

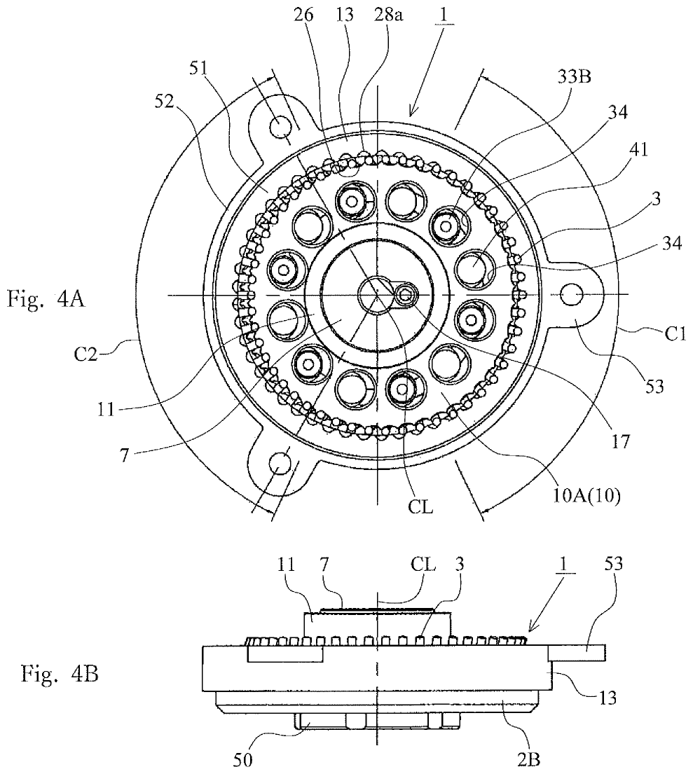

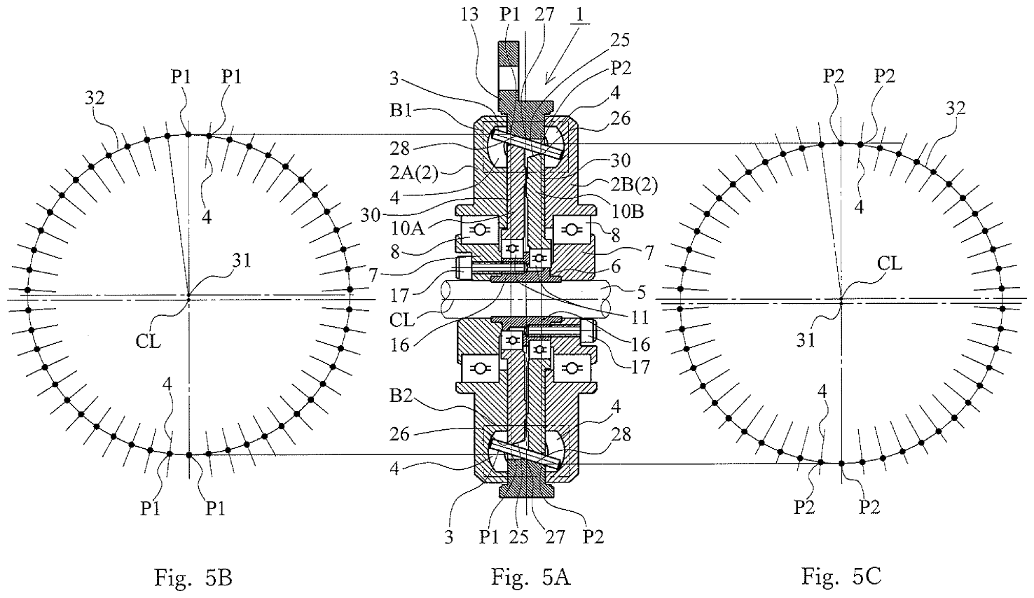

FIG. 1 to FIG. 5 are diagrams illustrating a reduction gear 1 according to an embodiment of the present invention. Note that, FIG. 1 is an external perspective view illustrating the reduction gear 1 according to the embodiment of the present invention when exploded and viewed from obliquely above. Further, FIG. 2(a) is a front view of the reduction gear 1, FIG. 2(b) is a side view of the reduction gear 1, and FIG. 2(c) is a back view of the reduction gear 1. Further, FIG. 3 is a cross-sectional view taken along the line A1-A1 of FIG. 2(a) to illustrate the reduction gear 1. Further, FIG. 4(a) is a front view illustrating the reduction gear 1 in which a first radial direction groove forming body 2A on a front side is removed, and FIG. 4(b) is a side view illustrating the reduction gear 1 in which the first radial direction groove forming body 2A on the front side is removed. Further, FIG. 5(a) is a cross-sectional view taken along the line A2-A2 of FIG. 2(a) to illustrate the reduction gear 1, FIG. 5(b) is a simplified view illustrating the relation between swing set points P1 on one end side of respective pins 3 and respective radial direction grooves 4 of the first radial direction groove forming body 2A, and FIG. 5(c) is a simplified view illustrating the relation between swing set points P2 on the other end side of the respective pins 3 and the respective radial direction grooves 4 of the second radial direction groove forming body 2B.

(Schematic Configuration of Reduction Gear)

As illustrated in FIG. 1 to FIG. 5, the reduction gear 1 according to the embodiment has an eccentric cam 6, a pair of input sleeves 7 and 7, a pair of swing bodies (first swing body 10A, second swing body 10B), the first radial direction groove forming body 2A, the second radial direction groove forming body 2B, a wave shape depressed portion forming body 13, and a plurality of the round rod shaped pins 3. The eccentric cam 6 turns integrally with a drive shaft (input side rotation body) 5. The input sleeves 7 and 7 turns integrally with the eccentric cam 6. The swing bodies (first swing body 10A, second swing body 10B) are relatively turnably mounted on an outer peripheral surface of the eccentric cam 6 via a bearing 8. The first radial direction groove forming body 2A is turnably fit on an outer peripheral side of the input sleeve 7 via a bearing 11 and arranged so as to face an outer side surface 12 of the first swing body 10A. The second radial direction groove forming body 2B is turnably fit on an outer peripheral side of the input sleeve 7 via the bearing 11 and arranged so as to face an outer side surface 12 of the second swing body 10B. The wave shape depressed portion forming body 13 is arranged on radially outward sides of the pair of swing bodies (first swing body 10A, second swing body 10B) and secured to a member to be fixed (not illustrated). The pins 3 are arranged so as to extend across outer peripheral surfaces of the pair of swing bodies (first swing body 10A, second swing body 10B). Note that a radial direction used in the description of the reduction gear 1 means a direction radially extending from a rotation shaft center CL of the drive shaft 5 in a virtual plane perpendicular to the rotation shaft center CL of the drive shaft 5. Further, a circumferential direction used in the description of the reduction gear 1 means a direction along a circumference of a virtual circle centering on the rotation shaft center CL of the drive shaft 5 in the virtual plane perpendicular to the rotation shaft center CL of the drive shaft 5.

(Eccentric Cam)

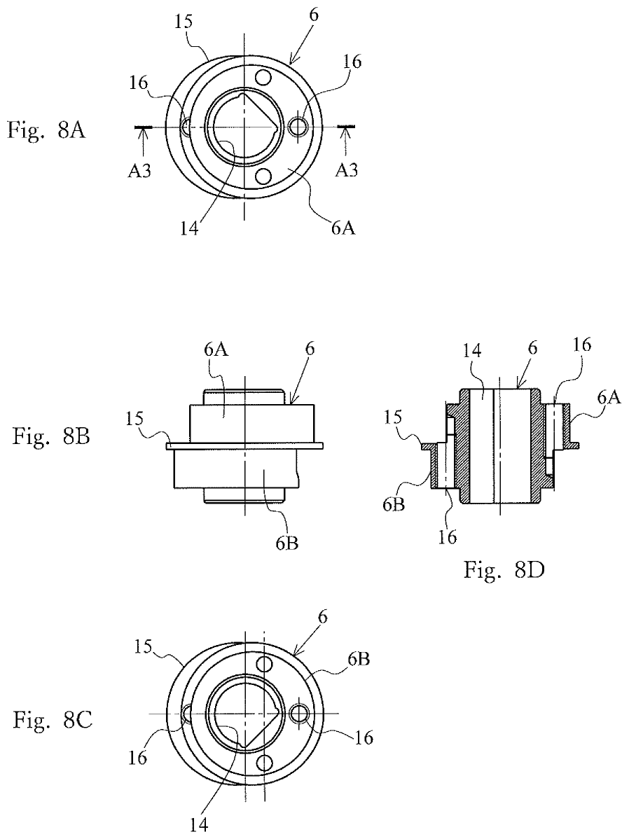

As illustrated in FIG. 3, FIG. 5, and FIG. 8, the eccentric cam 6 is fit in a state that the drive shaft 5 stops rotation in a shaft hole 14. The shaft hole 14 of the eccentric cam 6 passes through the eccentric cam 6 along the rotation shaft center CL and has a cross-sectional shape perpendicular to the rotation shaft center CL being D shape. The drive shaft 5 fitted in the shaft hole 14 has a cross-sectional shape perpendicular to the rotation shaft center CL being D shape. Further, in the eccentric cam 6, an annular collar portion 15 concentric with the rotation shaft center CL is formed at a center in the direction along the rotation shaft center CL, a first eccentric cam portion 6A is formed on one side along the rotation shaft center CL with the collar portion 15 as a boundary, and a second eccentric cam portion 6B is formed on the other side along the rotation shaft center CL with the collar portion 15 as the boundary. The first eccentric cam portion 6A and the second eccentric cam portion 6B have an equal decentering amount relative to the rotation shaft center CL and are in a rotationally symmetric positional relation centering on the rotation shaft center CL (positioned being shifted by 180° around the rotation shaft center CL). Then, the first swing body 10A is mounted on an outer peripheral surface of the first eccentric cam portion 6A so as to be relatively turnable via the bearing 11. Further, the second swing body 10B is mounted on an outer peripheral surface of the second eccentric cam portion 6B so as to be relatively turnable via the bearing 11. Further, a female screw 16 extending along the rotation shaft center CL is formed on an axial direction end surface of the first eccentric cam portion 6A and an axial direction end surface of the second eccentric cam portion 6B. Then, the input sleeve 7 is secured to the first eccentric cam portion 6A by a bolt 17 screwed into the female screw 16. Further, the input sleeve 7 is secured to the second eccentric cam portion 6B by the bolt 17 screwed into the female screw 16.

(Input Sleeve)

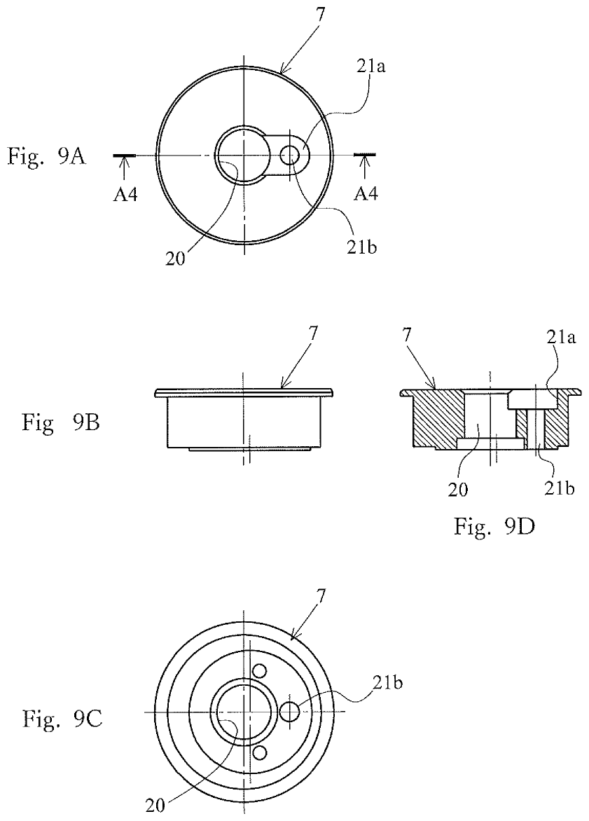

As illustrated in FIG. 3, FIG. 5, and FIG. 9, the pair of input sleeves 7 have a shaft hole 20 fitted by the drive shaft 5 and secured to the eccentric cam 6 with the bolts 17 to integrally turn with the drive shaft 5 and the eccentric cam 6. Then, the first radial direction groove forming body 2A or the second radial direction groove forming body 2B is mounted on the outer peripheral surfaces of the pair of input sleeves 7 and 7 via the bearing 11. This allows one of the pair of input sleeves 7 and 7 to support it such that the first radial direction groove forming body 2A can smoothly turn centering around the rotation shaft center CL of the drive shaft 5. The other of the pair of input sleeves 7 and 7 supports it such that the second radial direction groove forming body 2B can smoothly turn centering around the rotation shaft center CL of the drive shaft 5. Note that, as illustrated in FIG. 9, in the input sleeve 7, a counterbore hole 21a for housing a head of the bolt 17 and a bolt shaft hole 21b into which a shaft portion of the bolt 17 is inserted are formed.

(Swing Body)

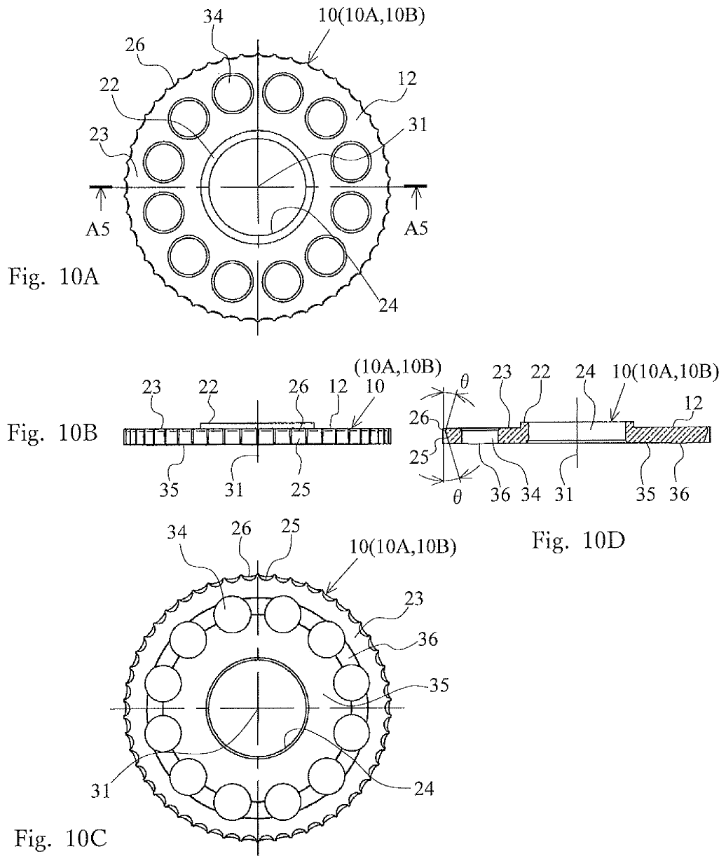

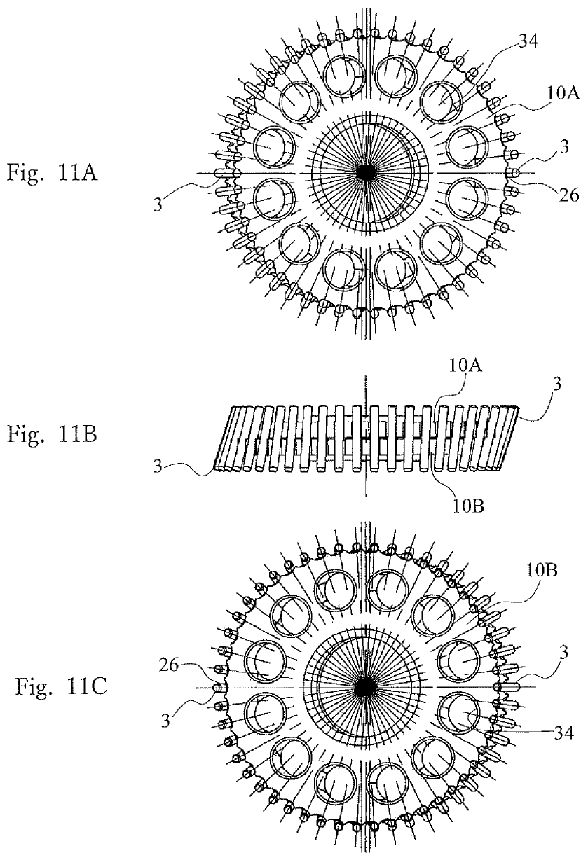

As illustrated in FIG. 1, FIG. 3 to FIG. 5, FIG. 10, and FIG. 11, in the swing body 10A (10B), a disk-shaped portion 23 is integrally formed on an outer peripheral side of a boss portion 22, and an eccentric cam mounting hole 24 is formed in the boss portion 22. For convenience of explanation, for the swing body 10A (10B), the one fitted to the first eccentric cam portion 6A via the bearing 8 is defined as the first swing body 10A, and the one fitted to the second eccentric cam portion 6b via the bearing 8 is defined as the second swing body 10B. The first swing body 10A and the second swing body 10B which have an identical shape are arranged back to back, and the first swing body 10A and the second swing body 10B are swung in a state of being shifted by 180° in phase. Further, the round rod shaped pins 3 extend across and contact outer peripheral sides of the first swing body 10A and the second swing body 10B. Further, on the outer peripheral sides of the first swing body 10A and the second swing body 10B, first pin supporting recess sites 25 and second pin supporting recess sites 26 are formed. The first pin supporting recess sites 25 and the second pin supporting recess sites 26 are formed at an inclination angle similar to a swing angle (θ) of the pin 3 corresponding to the decentering amount of the eccentric cam 6.

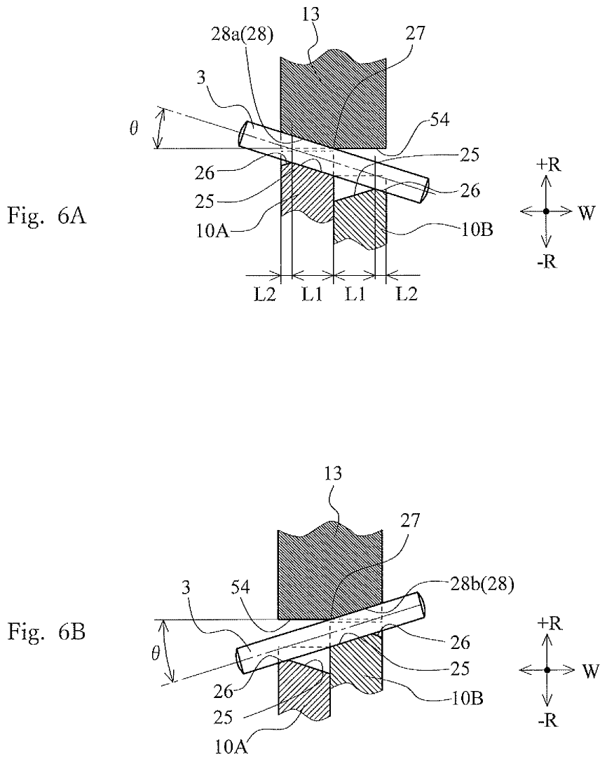

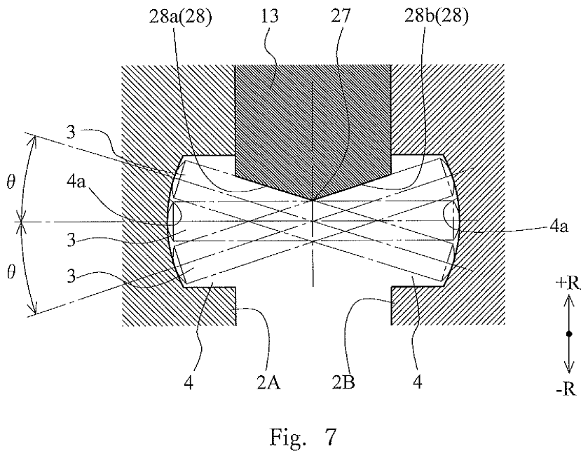

That is, as illustrated in FIG. 3 and FIG. 5, the first pin supporting recess site 25 of the first swing body 10A comes in line contact with the outer peripheral surface of the pin 3 when one end side of the pin 3 turns by an amount of the swing angle (θ) from a position of posture parallel to the rotation shaft center CL toward a radial direction outer (+R) side with a pin swing supporting portion 27 of the wave shape depressed portion forming body 13 as a fulcrum (see FIG. 6 and FIG. 7). Further, the second pin supporting recess site 26 of the first swing body 10A comes in line contact with the outer peripheral surface of the pin 3 when one end side of the pin 3 turns by an amount of the swing angle (θ) from a position of posture parallel to the rotation shaft center CL toward a radial direction inner (−R) side with the pin swing supporting portion 27 of the wave shape depressed portion forming body 13 as the fulcrum (see FIG. 6 and FIG. 7). Further, the first pin supporting recess site 25 of the second swing body 10B comes in line contact with the outer peripheral surface of the pin 3 when the other end side of the pin 3 turns by an amount of the swing angle (θ) from a position of posture parallel to the rotation shaft center CL toward the radial direction outer (+R) side with the pin swing supporting portion 27 of the wave shape depressed portion forming body 13 as the fulcrum (see FIG. 6 and FIG. 7). Further, the second pin supporting recess site 26 of the second swing body 10B comes in line contact with the outer peripheral surface of the pin 3 when the other end side of the pin 3 turns by an amount of the swing angle (θ) from a position of posture parallel to the rotation shaft center CL toward the radial direction inner (−R) side with the pin swing supporting portion 27 of the wave shape depressed portion forming body 13 as the fulcrum (see FIG. 6 and FIG. 7). Then, as illustrated in FIG. 5, in the first swing body 10A and the second swing body 10B, a boundary (ridgeline) between the first pin supporting recess site 25 and the second pin supporting recess site 26 is determined such that a width direction length (direction along the rotation shaft center CL) of the first pin supporting recess site 25 is longer than a width direction length of the second pin supporting recess site 26 (see FIG. 6). Thus, by making a length L1 in a width direction W of the first pin supporting recess site 25 longer than a length L2 in the width direction W of the second pin supporting recess site 26, the first swing body 10A and the second swing body 10B can reduce stress caused by rotational transmission load acting on the pin 3 and can transmit a larger rotating torque when transmitting the rotating torque with the pin 3 engaged with the wave shape depressed portion 28 of the wave shape depressed portion forming body 13, compared with a case where the length L1 in the width direction W of the first pin supporting recess site 25 is made equal to the length L2 in the width direction W of the second pin supporting recess site 26. The first pin supporting recess sites 25 and the second pin supporting recess sites 26 are continuously formed in wave shape along a circumferential direction of the first swing body 10A and the second swing body 10B. Note that, as illustrated in FIG. 4, the pin 3 has one end side in contact with a first wave shape depressed portion part 28a of the wave shape depressed portion forming body 13 in a wide range (C1) and the other end side in contact with a second wave shape depressed portion part 28b of the wave shape depressed portion forming body 13 in a wide range (C2).

FIG. 5(b) illustrates a virtual plane 30 extending outward in the radial direction from the boundary between the first pin supporting recess site 25 and the second pin supporting recess site 26 of the first swing body 10A and intersection points P1 (hereinafter, referred to as swing set points of the pins 3) between the virtual plane 30 perpendicular to the rotation shaft center CL and generating lines of the respective pins 3 in contact with the wave shape depressed portions 28 of the wave shape depressed portion forming body 13. The swing set points P1 of the respective pins 3 are positioned on a circle 32 concentric with a center 31 of the first swing body 10A. Similarly, FIG. 5(c) illustrates the virtual plane 30 extending outward in the radial direction from the boundary between the first pin supporting recess site 25 and the second pin supporting recess site 26 of the second swing body 10B and intersection points P2 (hereinafter, referred to as swing set points of the pins 3) between the virtual plane 30 perpendicular to the rotation shaft center CL and generating lines of the respective pins 3 in contact with the wave shape depressed portions 28 of the wave shape depressed portion forming body 13. The swing set points P2 of the respective pins 3 are positioned on the circle 32 concentric with the center 31 of the second swing body 10B.

Further, in the first swing body 10A and the second swing body 10B, a plurality (the same number as the sum total of rotation stopper projections 33A and 33B) of rotation stopper holes 34 which are engaged with a plurality of the rotation stopper projections 33A of the first radial direction groove forming body 2A and a plurality of the rotation stopper projections 33B of the second radial direction groove forming body 2B are formed. Then, in the first swing body 10A and the second swing body 10B, an inner diameter (D1) of the rotation stopper hole 34 is formed with a dimension (D1=d1+2e) which takes into consideration a decentering amount (e) of the eccentric cam 6 with an outer diameter (d1) of the rotation stopper projections 33A and 33B. As a result, while the first swing body 10A and the second swing body 10B are swung around the rotation shaft center CL of the drive shaft 5 by the eccentric cam 6, the first swing body 10A and the second swing body 10B are prevented from freely turning around the rotation shaft center CL of the drive shaft 5. Further, in the first swing body 10A and the second swing body 10B, an annular projection 36 projecting toward a back surface 35 side is integrally formed at a position in the radial direction where the rotation stopper holes 34 are formed. The annular projection 36 is bumped against when the first swing body 10A and the second swing body 10B are assembled back to back to the eccentric cam 6 and positions the first swing body 10A and the second swing body 10B in the direction along the rotation shaft center CL of the drive shaft 5.

(Radial Direction Groove Forming Body)

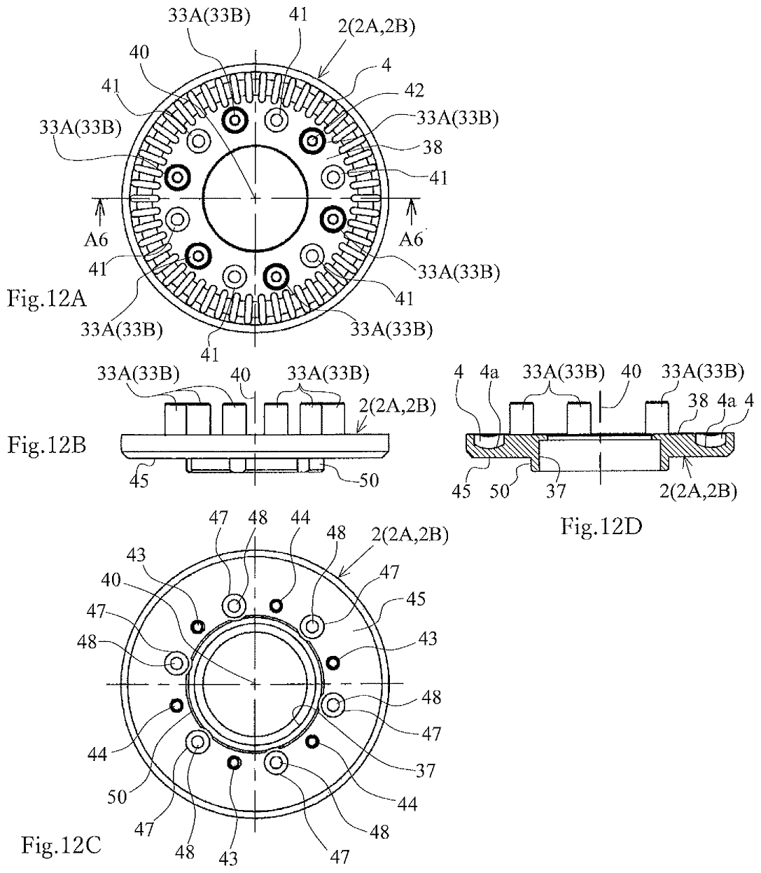

As illustrated in FIG. 1 to FIG. 5, and FIG. 12, a pair of radial direction groove forming bodies (output side rotation bodies) 2 are arranged so as to be faced by sandwiching the first swing body 10A and the second swing body 10B. One of the pair of radial direction groove forming bodies 2 and 2 is arranged so as to face the outer side surface 12 of the first swing body 10A and is fitted to the input sleeve 7 via the bearing 11. Further, the other of the pair of radial direction groove forming bodies 2 and 2 is arranged so as to face the outer side surface 12 of the second swing body 10B and is fitted to the input sleeve 7 via the bearing 11. Note that, in the following description, the radial direction groove forming body 2 arranged so as to face the outer side surface 12 of the first swing body 10A is appropriately referred to as the first radial direction groove forming body 2A. Further, the radial direction groove forming body 2 arranged so as to face the outer side surface 12 of the second swing body 10B is appropriately referred to as the second radial direction groove forming body 2B.

The radial direction groove forming body 2 is an approximately circular plate-shaped member concentric with the rotation shaft center CL of the drive shaft 5, has a bearing hole 37 fitted to an outer ring of the bearing 11 formed at a center portion, and has the same number of the radial direction grooves 4 as the pins 3 formed on an inner side surface 38 (surface facing the outer side surface 12 of the first swing body 10A or the outer side surface 10B of the second swing body 10B) on a radially outward side of the bearing hole 37. The radial direction groove 4 slidingly movably houses one end side or the other end side of the pin 3 that is swung (oscillated) by the first swing body 10A and the second swing body 10B and has a groove bottom wall 4a formed in an arc shape so as to be along a swing trajectory of an end face of the pin 3. Further, in the radial direction groove forming body 2, the rotation stopper projections 33A (33B) are formed at 6 positions equally spaced around a shaft center 40 on the inner side surface 38 and at a position between the radial direction grooves 4 and the bearing hole 37. The rotation stopper projections 33A (33B) are round rod shaped bodies projecting along the shaft center 40, pass and extend through the rotation stopper holes 34 of the first swing body 10A and the second swing body 10B, and are engaged with rotation stopper engaging holes 41 of the other radial direction groove forming body 2 arranged to be faced. The rotation stopper engaging hole 41 is formed at a position in a radial direction identical to the rotation stopper projection 33A (33B) and at an intermediate position between the adjacent rotation stopper projections 33A and 33A (33B and 33B). The rotation stopper engaging holes 41 have hole bottom surfaces that are bumped against by distal end surfaces of the rotation stopper projections 33B and 33B (33A and 33A) of the other facing radial direction groove forming body 2. Further, one end of a screw hole 42 extending along the shaft center 40 opens in a center of the distal end surface of the rotation stopper projection 33A (33B). Then, the other end of the screw hole 42 opens to a knock pin insertion hole 43 or opens to an output member connection screw hole 44. The knock pin insertion hole 43 and the output member connection screw hole 44 have opening ends positioned on an outer side surface 45 of the radial direction groove forming body 2 (surface that does not face the first swing body 10A or the second swing body 10B), are formed so as to be concentric with the center of the screw holes 42 of the rotation stopper projections 33A (33B), and are formed alternately along the circumferential direction. Further, in the radial direction groove forming body 2, counterbore holes 47 housing a head portion of a bolt 46 are formed on the outer side surface 45 and at positions corresponding to the rotation stopper engaging holes 41, and bolt shaft holes 48 where a shaft portion of the bolt 46 are inserted are engaged so as to communicate the counterbore holes 47 with the rotation stopper engaging holes 41. Further, on the outer side surface 45 of the radial direction groove forming body 2, a cylindrical flange 50 projecting so as to surround the bearing hole 37 is integrally formed. The shaft portion (male screw) of the bolt 46 inserted into the counterbore hole 47 and the bolt shaft hole 48 on one of the pair of radial direction groove forming bodies 2 and 2 is screwed with the screw hole (female screw) 42 formed in the rotation stopper projection 33A (33B) of the other of the pair of radial direction groove forming bodies 2 and 2, and tightened and secured by the bolt 46, thus allowing the pair of radial direction groove forming bodies 2 and 2 to integrally relatively turn with respect to the wave shape depressed portion forming body 13.

(Wave Shape Depressed Portion Forming Body)

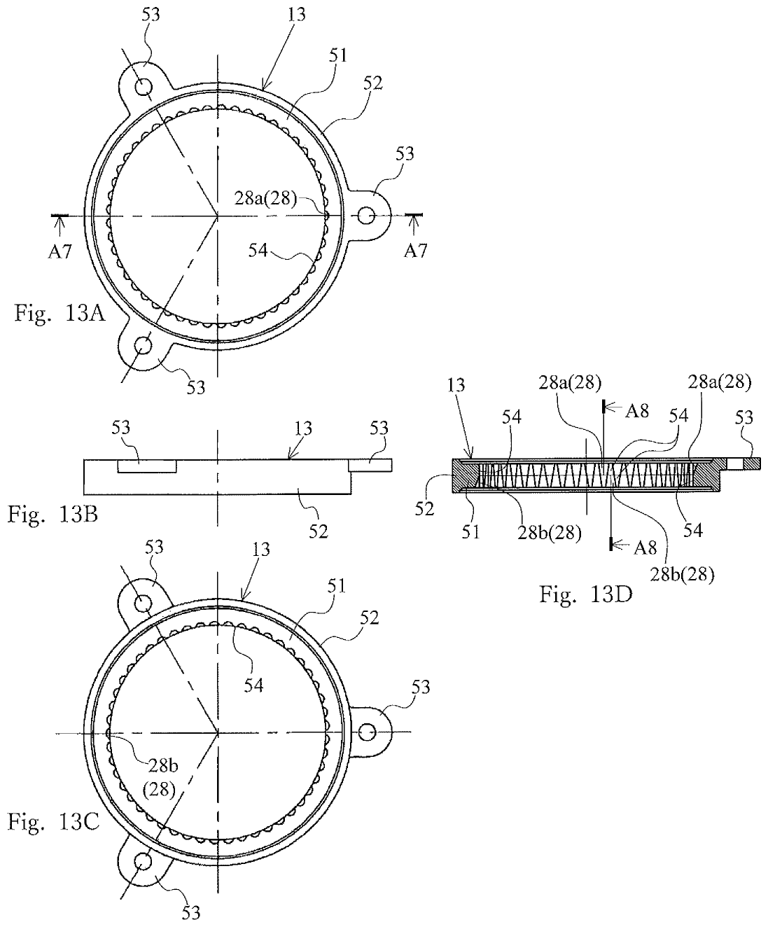

As illustrated in FIG. 1 to FIG. 5, and FIG. 13, the wave shape depressed portion forming body 13 is formed in an annular shape as a whole. Then, the wave shape depressed portion forming body 13 has a radial direction inner part 51 and a radial direction outer part 52. The radial direction inner part 51 is arranged between the pair of radial direction groove forming bodies 2 and 2 and on the radially outward side of the first swing body 10A and the second swing body 10B. The radial direction outer part 52 has a ring engaged with an outer peripheral surface of the pair of radial direction groove forming bodies 2 and 2. In the radial direction outer part 52, a tongue-shaped fixing portion 53 is formed at 3 positions along the circumferential direction, and the fixing portions 53 at 3 positions are fixed to fixing members outside the diagrams. As a result, the wave shape depressed portion forming body 13 relatively turns with the pair of radial direction groove forming bodies 2 and 2, the first swing body 10A and the second swing body 10B.

The radial direction inner part 51 has an inner circumference surface 54 where a plurality (Za-1 pieces when the number of the pins 3 is Za) of wave shape depressed portions 28 are formed. The wave shape depressed portions 28 are engaged with the pins 3 that are swung by the first swing body 10A and the second swing body 10B. The wave shape depressed portions 28 are not engaged when the pins 3 are in a posture parallel to the rotation shaft center CL of the drive shaft 5 (neutral posture for short). Further, the wave shape depressed portion 28 is constituted of the first wave shape depressed portion part 28a and the second wave shape depressed portion part 28b (see FIG. 6). The first wave shape depressed portion part 28a is engaged when one end side of the pin 3 swings to the radially outward side with the pin swing supporting portion 27 (center position in a width direction of the inner circumference surface 54) as a swing supporting point (oscillation supporting point) from the neutral posture. The second wave shape depressed portion part 28b is engaged when the other end side of the pin 3 swings to the radially outward side with the pin swing supporting portion 27 as a swing supporting point (oscillation supporting point) from the neutral posture. The first wave shape depressed portion part 28a and the second wave shape depressed portion part 28b are divided by the center in the width direction of the radial direction inner part 51 (pin swing supporting point portion 27), are inclined grooves formed at the inclination angle similar to the swing angle (θ) of the pin 3, and are engaged with the pin 3 each by half of a swing stroke of the pin 3. Therefore, the first wave shape depressed portion part 28a and the second wave shape depressed portion part 28b are formed in a state of being shifted by a half pitch in the circumferential direction. Further, the first wave shape depressed portion part 28a and the second wave shape depressed portion part 28b have a shape in a plan view formed in an arc shape and smoothly come into contact with the pin 3 swung by the first swing body 10A and the second swing body 10B. Then, in the adjacent wave shape depressed portions 28 and 28, a part of the inner circumference surface 54 of the radial direction inner part 51 is positioned between the adjacent first wave shape depressed portion parts 28a and 28a, and a part of the inner circumference surface 54 of the radial direction inner part 51 is positioned between the adjacent second wave shape depressed portion parts 28b and 28b. As a result, in the plurality of wave shape depressed portions 28 formed on the inner circumference surface 54 of the wave shape depressed portion forming body 13, the first wave shape depressed portion part 28a and the second wave shape depressed portion part 28b are positioned in the circumferential direction in a staggering shape (zigzag shape) (see FIG. 13(d)).

(Operation of Reduction Gear)

In the reduction gear 1 according to the embodiment configured as described above, when the drive shaft 5 makes one rotation, the first swing body 10A and the second swing body 10B are swung by the eccentric cam 6 and the first swing body 10A and the second swing body 10B cause the pin 3 to swing (oscillate) with the pin swing supporting point portion 27 as the fulcrum by one stroke. With this, one end side of the pin 3 makes one round trip in the radial direction groove 4 of the first radial direction groove forming body 2A, and at the same time, the one end side of the pin 3 moves in the first wave shape depressed portion part 28a of the wave shape depressed portion forming body 13 along the circumferential direction. Further, the other end side of the pin 3 makes one round trip in the radial direction groove 4 of the second radial direction groove forming body 2B, and at the same time, the other end side of the pin 3 moves in the second wave shape depressed portion part 28b of the wave shape depressed portion forming body 13 along the circumferential direction.

In the reduction gear 1 having such a structure, when the number of grooves of the radial direction grooves 4 and the number of the pins 3 are defined as Za, the number of the wave shape depressed portions 28 (first wave shape depressed portion part 28a and second wave shape depressed portion part 28b) is defined as Zb, and Za is one more than Zb, the first radial direction groove forming body 2A and the second radial direction groove forming body 2B turn with respect to the wave shape depressed portion forming body 13 and the rotation of the drive shaft 5 can be decelerate to 1/Za and taken out from the first radial direction groove forming body 2A and the second radial direction groove forming body 2B. In this case, the rotation direction of the first radial direction groove forming body 2A and the second radial direction groove forming body 2B is a direction identical to the drive shaft 5.

Further, in the reduction gear 1 having the structure described above, when the number of grooves of the radial direction grooves 4 and the number of the pins 3 is defined as Za, the number of the wave shape depressed portions 28 (first wave shape depressed portion part 28a and second wave shape depressed portion part 28b) is defined as Zb, and Za is one less than Zb, the first radial direction groove forming body 2a and the second radial direction groove forming body 2b turn with respect to the wave shape depressed portion forming body 13 and the rotation of the drive shaft 5 can be decelerate to 1/Za and taken out from the first radial direction groove forming body 2a and the second radial direction groove forming body 2b. In this case, the rotation direction of the first radial direction groove forming body 2a and the second radial direction groove forming body 2b is a reverse direction of the drive shaft 5.

### Effects of Embodiment

In the reduction gear 1 according to the embodiment described above, while the first swing body 10A and the second swing body 10B are swung with respect to the rotation shaft center CL of the drive shaft (input side rotation body) 5, the first radial direction groove forming body 2A and the second radial direction groove forming body 2B are not eccentrically turned by the swinging first swing body 10A and the second swing body 10B, and thus, the rotation can be taken out from the first radial direction groove forming body 2A and the second radial direction groove forming body 2B without separately providing an eccentric motion absorbing mechanism (for example, an Oldham's joint) 108 which is provided in a conventional cycloid reduction gear 100, and the structure can be simplified as well as downsized.

(Modification 1 of Swing Body)

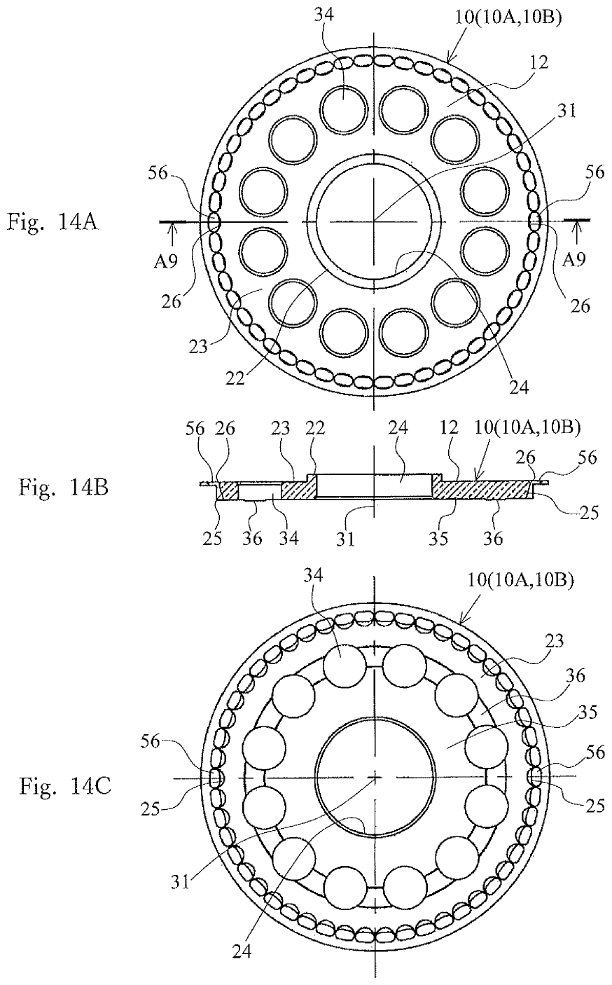

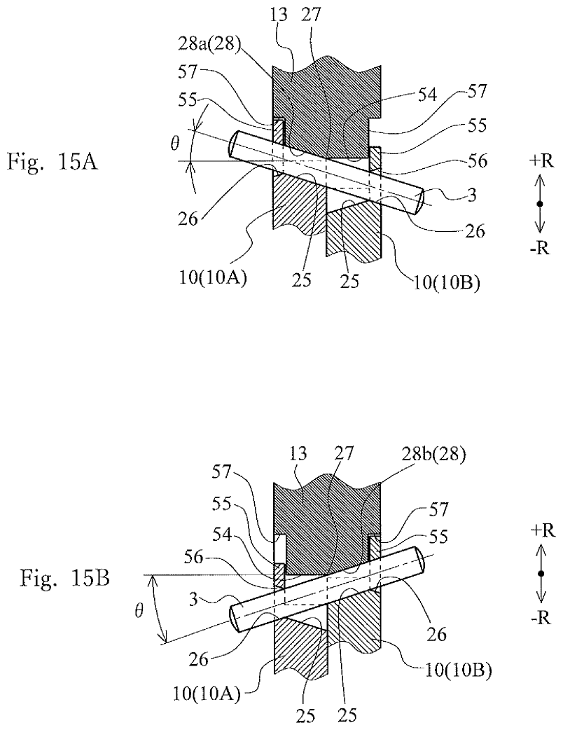

FIG. 14 is a diagram illustrating a modification of the swing body 10 (first swing body 10A and second swing body 10B) according to the above-described embodiment. The same components as those in the swing body 10 according to the above-described embodiment are denoted by the same reference numerals, and the description overlapped with the description of the swing body 10 according to the above-described embodiment is omitted. Further, FIG. 15 is a diagram illustrating a swing state of the pin 3 when the swing body 10 according to this modification is used. Note that FIG. 14(a) is a front view of the swing body 10. Further, FIG. 14(b) is a cross-sectional view taken along the line A10-A10 of FIG. 14(a) to illustrate the swing body 10. Further, FIG. 14(c) is a back view of the swing body 10. Further, FIG. 15(a) is a first swing state view of the pin 3. Further, FIG. 15(b) is a second swing state view of the pin 3.

Similarly to the swing body 10 according to the above-described embodiment, for the swing body 10 according to this modification illustrated in FIG. 14, a pair of swing bodies 10 having an identical shape are used back to back. The one fitted to the first eccentric cam portion 6A via the bearing 8 is defined as the first swing body 10A, and the one fitted to the second eccentric cam portion 6B via the bearing 8 is defined as the second swing body 10B. Then, the first swing body 10A and the second swing body 10B are swung in a state of being shifted by 180° in phase.

In the swing body 10 according to this modification, a collar portion 55 formed in a width dimension identical to a width dimension of the second pin supporting recess site 26 is integrally formed on a radial direction outer end side and one end side in a width direction, and a pin housing hole 56 is formed in the collar portion 55. The pin housing hole 56 is formed at an inclination angle θ identical to the swing angle of the pin 3 such that a radial direction lower surface is the second pin supporting recess site 26 and a radial direction upper surface constitutes a part of the first wave shape depressed portion part 28a or the second wave shape depressed portion part 28b of the wave shape depressed portion forming body 13. Further, the pin housing hole 56 is an elongated hole in consideration of the decentering amount (e) of the eccentric cam 6. Then, when the diameter of the pin 3 is defined as d and the swing angle of the pin 3 is defined as θ, the narrowest portion of the distance along the radial direction between the radial direction lower surface and the radial direction upper surface of the pin housing hole 56 has a dimension of L=(d/cos θ). As a result, the swing body 10 according to this modification can support one end side or the other end side of the pin 3 with the pin housing hole 56 and suppress rattling of swing (oscillation) motion of the pin 3. Therefore, when the pin 3 swings (oscillates) with the pin swing supporting portion 27 as the fulcrum, the pin 3 can be smoothly brought into contact with the first wave shape depressed portion part 28a or the second wave shape depressed portion part 28b of the wave shape depressed portion forming body 13 and operation noise of the reduction gear 1 caused by collision noise between the pin 3 and the wave shape depressed portion forming body 13 can be made quieter. Note that, on both side surfaces of the wave shape depressed portion forming body 13, an annular collar portion housing recess site 57 which houses the collar portion 55 of the swing body 10 is formed.

(Modification 2 of Swing Body)

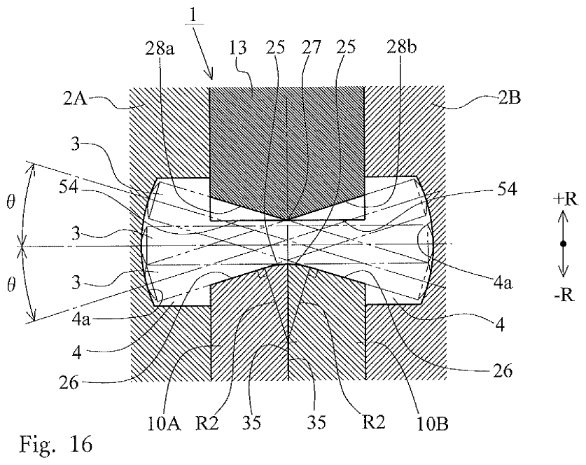

FIG. 16 is a diagram illustrating a modification 2 of the swing body 10 (first swing body 10A, second swing body 10B), and the diagram corresponding to FIG. 7. As illustrated in FIG. 16, in the reduction gear 1 using the swing body 10 according to the modification 2, one end side of the pin 3 is swung to a radially outward side by the first swing body 10A, and when the pin 3 is swung to the swing angle θ identical to the inclination angle of the first wave shape depressed portion part 28a of the wave shape depressed portion forming body 13, the other end side of the pin 3 is supported by the second pin supporting recess site 26 of the second swing body 10B. Further, in the reduction gear 1 using the swing body 10 according to the modification 2, one end side of the pin 3 is swung to a radial direction inner side by the second swing body 10B, and when the pin 3 is swung to the swing angle θ identical to the inclination angle of the second wave shape depressed portion part 28b of the wave shape depressed portion forming body 13, the one end side of the pin 3 is supported by the second pin supporting recess site 26 of the first swing body 10A. Further, in the modification 2, in the first swing body 10A and the second swing body 10B, the first pin supporting recess sites 25 are formed. The first pin supporting recess site 25 is shaped by a curved surface having a curvature radius R2 whose center of curvature is positioned on the back surface 35. The first pin supporting recess sites 25 of the first swing body 10A and the second swing body 10B come into contact with the pins 3 which are not swinging at radial direction outer ends of the back surfaces 35 (pins 3 having a posture parallel to the rotation shaft center CL of the drive shaft 5) and are smoothly coupled to the second pin supporting recess sites 26.

Similarly to the reduction gear 1 according to the above-described embodiment, in the reduction gear 1 using the swing body 10 according to the modification 2 as described, an engagement depth between one end side of the pin 3 and the first wave shape depressed portion part 28a of the wave shape depressed portion forming body 13 can be made similar to the reduction gear 1 according to the above-described embodiment, and an engagement depth between the other end side of the pin 3 and the second wave shape depressed portion part 28b of the wave shape depressed portion forming body 13 can be made similar to the reduction gear 1 according to the above-described embodiment.

(Modification of Pin Swing Supporting Portion)

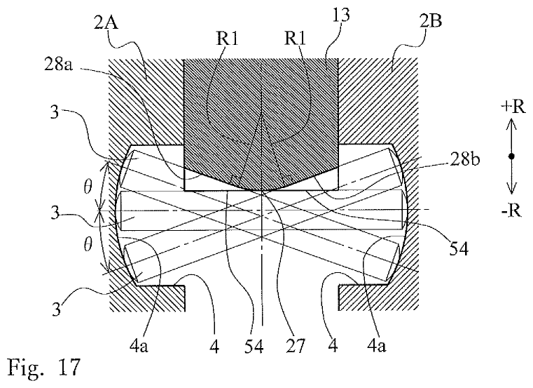

FIG. 17 is a diagram illustrating a modification of the pin swing supporting portion 27 of the wave shape depressed portion forming body 13, and the diagram corresponding to FIG. 7. As illustrated in FIG. 17, in the pin swing supporting portion 27 of the modification 1, a groove bottom surface of the first wave shape depressed portion part 28a of the wave shape depressed portion forming body 13 is smoothly coupled to the inner circumference surface 54 of the wave shape depressed portion forming body 13 by a curved surface of a curvature radius R1, and a groove bottom surface of the second wave shape depressed portion part 28b of the wave shape depressed portion forming body 13 is smoothly coupled to the inner circumference surface 54 of the wave shape depressed portion forming body 13 by the curved surface of the curvature radius R1. By configuring in this way, an engagement depth between the pin 3 and the first wave shape depressed portion part 28a and an engagement depth between the pin 3 and the second wave shape depressed portion part 28b can be made shallow compared with the above-described embodiment.

(Modification of Wave Shape Depressed Portion Forming Body)

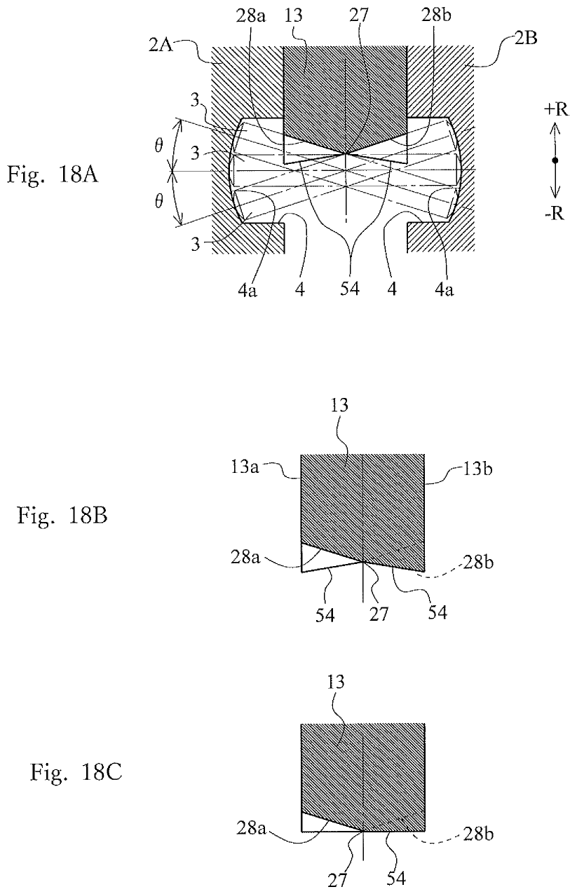

FIG. 18(a) is a diagram illustrating a modification of the wave shape depressed portion forming body 13, and the diagram corresponding to FIG. 7. Further, FIG. 18(b) is a cross-sectional view of the inner circumference surface 54 side of the wave shape depressed portion forming body 13 according to this modification. Further, FIG. 18(c) is a cross-sectional view of the inner circumference surface 54 side of the wave shape depressed portion forming body 13 according to the above-described embodiment.

As illustrated in FIG. 18, the wave shape depressed portion forming body 13 is formed to gradually reduce an inner diameter size from the pin swing supporting portion 27 (center position in a width direction) toward a front surface 13a side along the width direction such that a depression depth of the first wave shape depressed portion part 28a becomes deeper than a depression depth of the first wave shape depressed portion part 28a of the above-described embodiment. Further, the wave shape depressed portion forming body 13 is formed to gradually reduce an inner diameter size from the pin swing supporting portion 27 toward a back surface 13b side along the width direction such that a depression depth of the second wave shape depressed portion part 28b becomes deeper than a depression depth of the second wave shape depressed portion part 28b of the above-described embodiment.

In the wave shape depressed portion forming body 13 according to this modification, the number of the pins 3 in contact with the first wave shape depressed portion part 28a or the second wave shape depressed portion part 28b increases more than the case where the wave shape depressed portion forming body 13 according to the above-described embodiment is used, and a larger torque than the case where the wave shape depressed portion forming body 13 according to the above-described embodiment is used can be transmitted.

(Other Modifications)

Although examples of the reduction gear 1 according to the above-described embodiment and the modification where the same number of the radial direction grooves 4 as the pins 3 are formed is shown, the present invention is not limited to these, and more radial direction grooves 4 than the pins 3 may be formed (for example, when the number of the pins 3 is defined as Z1 and the number of the radial direction grooves 4 is defined as Z2, Z2=2·Z1 may be set). Note that, in this case, the difference between the number of the radial direction grooves 4 and the number of the wave shape depressed portion 28 (first wave shape depressed portion part 28a and second wave shape depressed portion part 28b) is set to be 1.

Further, the reduction gear 1 according to the present invention is not limited to the reduction gear 1 according to the above-described embodiment (reduction gear 1 where the wave shape depressed portion forming body 13 is secured and rotation is taken out from the first radial direction groove forming body 2A and second radial direction groove forming body 2B), and the first radial direction groove forming body 2A and the second radial direction groove forming body 2B may be secured and the rotation may be taken out from the wave shape depressed portion forming body 13.

### DESCRIPTION OF REFERENCE SIGNS

1 Reduction gear
2A First radial direction groove forming body
2B Second radial direction groove forming body
3 Pin
4 Radial direction groove
5 Drive shaft (input side rotation body)
6 Eccentric cam
10A First swing body
10B Second swing body
13 Wave shape depressed portion forming body
28 Wave shape depressed portion
CL Rotation shaft center

1. A reduction gear that decelerates and transmits rotation of an input side rotation body to an output side rotation body, the reduction gear comprising:
an eccentric cam that turns together with the input side rotation body;
a first swing body relatively turnably fitted to the eccentric cam and swung by the eccentric cam that turns in an eccentric state with respect to a rotation shaft center of the input side rotation body;
a second swing body that is relatively turnably fitted to the eccentric cam, swung by the eccentric cam that turns in an eccentric state with respect to the rotation shaft center of the input side rotation body, and swung in a state of being shifted by 180° in phase with respect to the first swing body;
a plurality of round rod shaped pins that extend across and contact outer peripheries of the first swing body and the second swing body and are swung by swing motions of the first swing body and the second swing body;
a first radial direction groove forming body, a direction extending radially from the rotation shaft center of the input side rotation body being defined as a radial direction, a direction along a circumference of a virtual circle centering on the rotation shaft center of the input side rotation body being defined as a circumferential direction, at least a same number of radial direction grooves as a number of the pins being formed in the first radial direction groove forming body, the radial direction grooves allowing one end sides of the pins swung and moved by the first swing body and the second swing body to slidingly move along the radial direction;
a second radial direction groove forming body integrated with the first radial direction groove forming body, at least a same number of radial direction grooves as the number of the pins being formed in the second radial direction groove forming body, the radial direction grooves allowing other end sides of the pins swung and moved by the first swing body and the second swing body to slidingly move along the radial direction; and
a wave shape depressed portion forming body positioned on radially outward sides of the first swing body and the second swing body and having a wave shape depressed portion formed along the circumferential direction, the wave shape depressed portion being into contact with the pin slidingly moved along the radial direction groove, wherein
one of the first radial direction groove forming body and second radial direction groove forming body or the wave shape depressed portion forming body is secured to a member to be fixed,
another of the first radial direction groove forming body and second radial direction groove forming body or the wave shape depressed portion forming body is arranged relatively turnably with the one of the first radial direction groove forming body and second radial direction groove forming body or the wave shape depressed portion forming body, the first swing body, and the second swing body, and
when the number of grooves of the radial direction grooves is defined as Za and the number of the wave shape depressed portions is defined as Zb, a plurality of the wave shape depressed portions are formed along the circumferential direction of the wave shape depressed portion forming body such that a difference between Za and Zb becomes 1.

2. The reduction gear according to claim 1, wherein
the radial direction groove has a groove bottom wall formed along a swing trajectory on an end portion of the pin.

3. The reduction gear according to claim 1, wherein
the wave shape depressed portion forming body has an inner circumference surface parallel to the rotation shaft center, a direction along the rotation shaft center of the inner circumference surface is defined as a width direction, and the wave shape depressed portion forming body has the wave shape depressed portion formed such that a middle in the width direction of the inner circumference surface becomes a swing supporting point of the pin,
the wave shape depressed portion has a first wave shape depressed portion part and a second wave shape depressed portion part alternately formed along the circumferential direction of the inner circumference surface, the first wave shape depressed portion part gradually increasing in depth from the middle in the width direction toward one end side of the width direction and formed at an inclination angle corresponding to a swing angle of the pin, the second wave shape depressed portion part gradually increasing in depth from the middle in the width direction toward another end side of the width direction and formed at an inclination angle corresponding to a swing angle of the pin,
when a direction along the rotation shaft center is defined as a width direction, the first swing body has a first pin supporting recess site and a second pin supporting recess site separately formed in the width direction of the outer peripheral surface, the first pin supporting recess site formed at an inclination angle identical to the inclination angle of one of the first wave shape depressed portion part or the second wave shape depressed portion part, the second pin supporting recess site formed at an inclination angle identical to the inclination angle of another of the first wave shape depressed portion part or the second wave shape depressed portion part, and
when a direction along the rotation shaft center is defined as a width direction, the second swing body has a first pin supporting recess site and a second pin supporting recess site separately formed in the width direction of the outer peripheral surface, the first pin supporting recess site formed at an inclination angle identical to the inclination angle of the other of the first wave shape depressed portion part or the second wave shape depressed portion part, the second pin supporting recess site formed at an inclination angle identical to the inclination angle of the one of the first wave shape depressed portion part or the second wave shape depressed portion part.

4. The reduction gear according to claim 3, wherein
the first swing body and the second swing body have a dimension along the width direction of the first pin supporting recess site larger than a dimension along the width direction of the second supporting pin supporting recess site.

5. The reduction gear according to claim 4, wherein
a pin housing hole is formed to have an inner circumference surface that serves as the second supporting pin supporting recess site on an outer end side in the radial direction of the first swing body and the second swing body and on one end side in the width direction, and
the pin housing hole swingably houses the pin and restricts the pin from swinging by equal to or more than the swing angle.

6. The reduction gear according to claim 2, wherein
the wave shape depressed portion forming body has an inner circumference surface parallel to the rotation shaft center, a direction along the rotation shaft center of the inner circumference surface is defined as a width direction, and the wave shape depressed portion forming body has the wave shape depressed portion formed such that a middle in the width direction of the inner circumference surface becomes a swing supporting point of the pin,
the wave shape depressed portion has a first wave shape depressed portion part and a second wave shape depressed portion part alternately formed along the circumferential direction of the inner circumference surface, the first wave shape depressed portion part gradually increasing in depth from the middle in the width direction toward one end side of the width direction and formed at an inclination angle corresponding to a swing angle of the pin, the second wave shape depressed portion part gradually increasing in depth from the middle in the width direction toward another end side of the width direction and formed at an inclination angle corresponding to a swing angle of the pin,
when a direction along the rotation shaft center is defined as a width direction, the first swing body has a first pin supporting recess site and a second pin supporting recess site separately formed in the width direction of the outer peripheral surface, the first pin supporting recess site formed at an inclination angle identical to the inclination angle of one of the first wave shape depressed portion part or the second wave shape depressed portion part, the second pin supporting recess site formed at an inclination angle identical to the inclination angle of another of the first wave shape depressed portion part or the second wave shape depressed portion part, and
when a direction along the rotation shaft center is defined as a width direction, the second swing body has a first pin supporting recess site and a second pin supporting recess site separately formed in the width direction of the outer peripheral surface, the first pin supporting recess site formed at an inclination angle identical to the inclination angle of the other of the first wave shape depressed portion part or the second wave shape depressed portion part, the second pin supporting recess site formed at an inclination angle identical to the inclination angle of the one of the first wave shape depressed portion part or the second wave shape depressed portion part.

7. The reduction gear according to claim 6, wherein
the first swing body and the second swing body have a dimension along the width direction of the first pin supporting recess site larger than a dimension along the width direction of the second supporting pin supporting recess site.

8. The reduction gear according to claim 7, wherein
a pin housing hole is formed to have an inner circumference surface that serves as the second supporting pin supporting recess site on an outer end side in the radial direction of the first swing body and the second swing body and on one end side in the width direction, and
the pin housing hole swingably houses the pin and restricts the pin from swinging by equal to or more than the swing angle.
